(19) United States
(12) Patent Application Publication
(10) Pub. No.: US 2021/0362638 A1
(43) Pub. Date: Nov. 25, 2021

(54) METHOD AND APPARATUS FOR RETAINING HOSES ON A TANKER TRUCK

(71) Applicant: Mac LTT, Inc., Kent, OH (US)

(72) Inventors: James A. Maiorana, Hartville, OH (US); Anthony Miller, Lorain, OH (US)

(73) Assignee: Mac LTT, Inc., Kent, OH (US)

(21) Appl. No.: 16/881,408

(22) Filed: May 22, 2020

(51) Int. Cl. B60P 3/22; B60P 7/12; B60P 7/08

(52) U.S. Cl. CPC B60P 3/2265; B60P 7/0807; B60P 7/12

(57) ABSTRACT

A vehicle includes a tank, a hose holder, and a retaining rod. The hose holder is connected to the vehicle and positioned adjacent to the tank. The hose holder includes a hose carrying bed. The retaining rod is connected to the hose holder. The retaining rod extends over the hose holder bed.

### TECHNICAL FIELD

The following generally relates to trucks. More specifically, the following relates to tanker trucks. More specifically, the following relates to hose holders of tanker trucks.

### BACKGROUND

Tanker trucks, including fuel carrying tanker trucks, include a trailer with a hollow interior for transporting material and hoses for transferring the material from the trailer to a storage receptacle. Generally, the hoses are transported in a hose holder that is connected to a side of trailer. The hoses are carried by the hose holder while the vehicle is moving by a strap or bungee cord. The strap or bungee cord may be pulled from the one side of the hose holder, over the hoses carried by the hose holder and strapped to an opposing side of the hose holder.

Unfortunately, during the transfer process or while driving in adverse weather conditions, the hoses may become dirty. In order to remove or store the hoses, a driver may have to reach across the dirty hoses to attach/detach a strap or a bungee cord. As a result, the driver's arm or sleeve may brush up against a dirty hose thereby dirtying the driver. Furthermore, due to the height of the hose holder, it may be difficult for a driver to reach across the hose holder when removing or storing a hose.

### SUMMARY

For at least the reasons stated herein, there is a continuous unmet need for a device that retains hoses within a hose holder connected to a truck that does not require a user to reach across the hose holder in order to secure the device to the hose holder. Aspects of the present disclosure are directed to this continuous unmet need.

In one aspect, an exemplary embodiment of the present disclosure may provide a vehicle. The vehicle may include a tank, a hose holder, and a retaining rod. The hose holder may be connected to the vehicle and may be positioned adjacent to the tank. The hose holder may include a hose carrying bed. The retaining rod may be connected to the hose holder and may extend over the hose carrying bed. This exemplary embodiment or another exemplary embodiment may provide wherein the hose holder further includes a first side wall adjacent to the tank and a second side wall spaced from the first side wall and a catch, wherein the hose holder bed extends between the first side wall and the second side wall, and wherein the catch extends from the second side wall and the retaining rod is removably attached to the catch. This exemplary embodiment or another exemplary embodiment may provide wherein the retaining rod is moveable between an open position and a closed position, and wherein the retaining rod is releasably attached to the catch. This exemplary embodiment or another exemplary embodiment may provide wherein the retaining rod includes a first end, a second end opposite the first end, an attachment assembly that defines the second end, and wherein the attachment assembly is removably attached to the catch.

This exemplary embodiment or another exemplary embodiment may provide wherein the attachment assembly includes a closed hook that is removably attached to the catch. This exemplary embodiment or another exemplary embodiment may provide wherein the hose holder includes an anchor carried by the first side wall, wherein the anchor retains the retaining rod. This exemplary embodiment or another exemplary embodiment may provide wherein the anchor defines an aperture and a portion of the retaining rod extends through the aperture. This exemplary embodiment or another exemplary embodiment may provide wherein the retaining rod is manufactured of a flexible material. This exemplary embodiment or another exemplary embodiment may provide wherein the flexible material is one of fiberglass, aluminum, carbon fiber, or springing steel. This exemplary embodiment or another exemplary embodiment may provide a spring bias for moving the retaining rod from the closed positon to the open position. This exemplary embodiment or another exemplary embodiment may provide wherein the spring bias includes a sprig for moving the retaining rod from the closed position to the open position. This exemplary embodiment or another exemplary embodiment may provide a central vertical plane extending through hose holder bed, wherein the retaining rod extends at least to the central vertical plane when in the open position.

In another aspect, an exemplary embodiment of the present disclosure may provide a method for retaining hoses. The method may include placing a hose into a hose holder. The hose holder may be connected to a vehicle. The method may further include moving a retaining rod from an open position to a closed positon. In the open position a first end of the retaining rod may be attached to the hose holder and in the closed position the first end and a second end of the retaining rod may be attached to the hose holder. This exemplary embodiment or another exemplary embodiment may provide wherein when the retaining rod is in the open position, the second end of the retaining rod is vertically above a hose holder bed of the hose holder. This exemplary embodiment or another exemplary embodiment may provide wherein when the retaining rod is in the open position, the second end of the retaining rod extends beyond the second end of the retaining rod extends beyond a central vertical plane of the hose holder relative to the vehicle.

This exemplary embodiment or another exemplary embodiment may provide wherein the hose holder includes a catch and wherein the method further includes attaching the second end of the retaining rod to the catch thereby placing the retaining rod in the closed positon. This exemplary embodiment or another exemplary embodiment may provide overcoming a spring bias to move the retaining rod from the open position to the closed position. This exemplary embodiment or another exemplary embodiment may provide wherein the step of overcoming the spring bias to move the retaining rod from the open position to the closed position includes flexing a flexible rod of the retaining rod. This exemplary embodiment or another exemplary embodiment may provide wherein the spring bias automatically moves the retaining rod from the closed position to the open position. This exemplary embodiment or another exemplary embodiment may provide wherein attaching the second end of the retaining to the catch causes the retaining to store potential energy. This exemplary embodiment or another exemplary embodiment may provide releasing the second end of the retaining rod from the catch, wherein releasing the second end of the retaining rod from the catch causes the retain rod to release the stored potential energy thereby moving the retaining rod to the open position.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 (FIG. 1) is a side view of a vehicle with a trailer and a hose holder connected to the trailer.

FIG. 2 (FIG. 2) is an elevated side view of the trailer and hose holder depicted in FIG. 1.

FIG. 3 (FIG. 3) is an enlarged elevated side view of a portion of the trailer and hose holder depicted in FIG. 2.

FIG. 4A (FIG. 4A) is a cross sectional view of the trailer and hose holder depicted in FIG. 3 taken along the line 4A-4A.

FIG. 4B (FIG. 4B) is another cross sectional view of the trailer and hose holder depicted in FIG. 3 taken along the line 4A-4A.

FIG. 4C (FIG. 4C) is another cross sectional view of the trailer and hose holder depicted in FIG. 3 taken along the line 4A-4A.

FIG. 5 (FIG. 5) is another enlarged elevated side view of a portion of the trailer and hose holder depicted in FIG. 2 wherein the hoses have been removed from the hose holder.

FIG. 6A (FIG. 6A) is a cross sectional view of a trailer and a hose holder with a flexible retaining arm in an open position.

FIG. 6B (FIG. 6B) is a cross sectional view of the trailer and the hose holder depicted in FIG. 6A with a flexible retaining arm in a closed position

Similar numbers refer to similar parts throughout the drawings.

### DETAILED DESCRIPTION

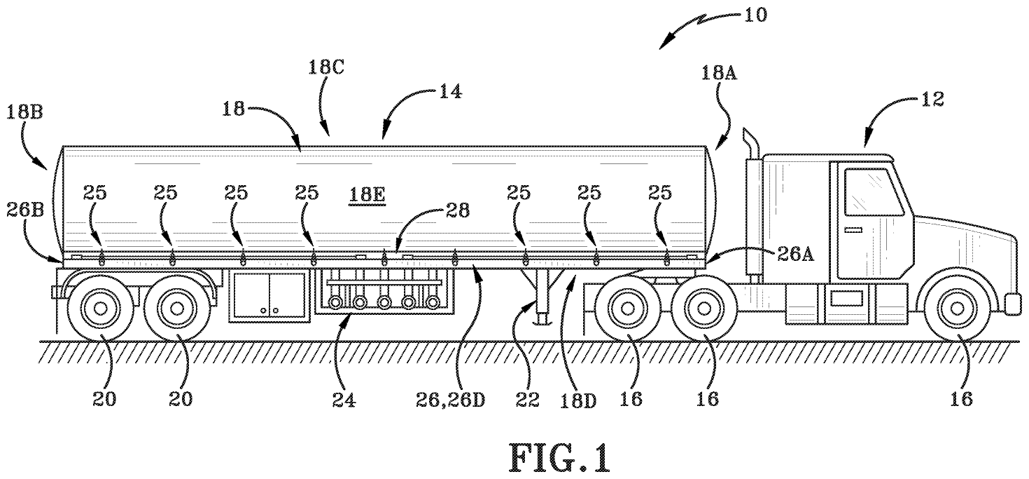

FIG. 1 depicts a vehicle 10. The vehicle 10 may include a tractor unit or cab 12 and a trailer 14. The cab 12 may be connected to the trailer 14 to provide a pulling force to the trailer 14. The cab 12 may include a one or more pairs of wheel assemblies 16 that support the cab 12 and the trailer 14. The trailer 14 may include a tank 18, one or more pairs of wheel assemblies 20, a landing gear 22, a nozzle assembly 24, and a hose holder 26. The one or more wheel assemblies 20 may support the tank 18 and when the vehicle 10 is stationary, the landing gear 22 may also support the tank 18. The tank 18 may include a hollow interior for transporting material (i.e., fuel, liquid, grain, etc.) and the shape and size of the tank 18 may be dependent upon the material being transported. While the tank 18 is depicted as a generally cylindrical tank 18, it is envisioned that the tank 18 may be a non-cylindrical.

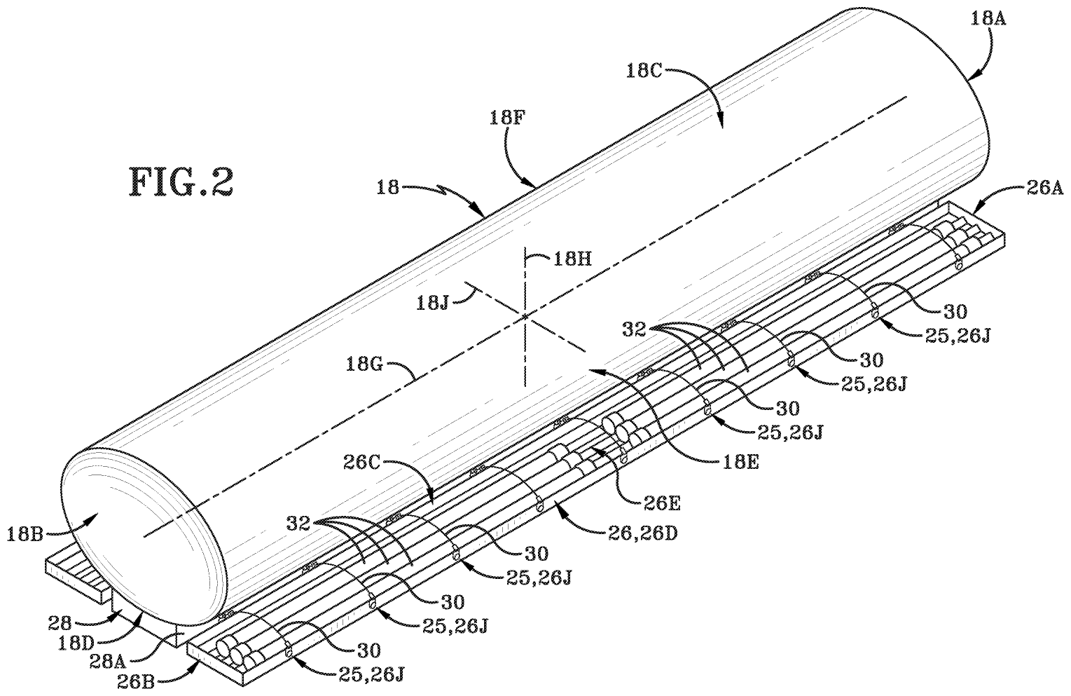

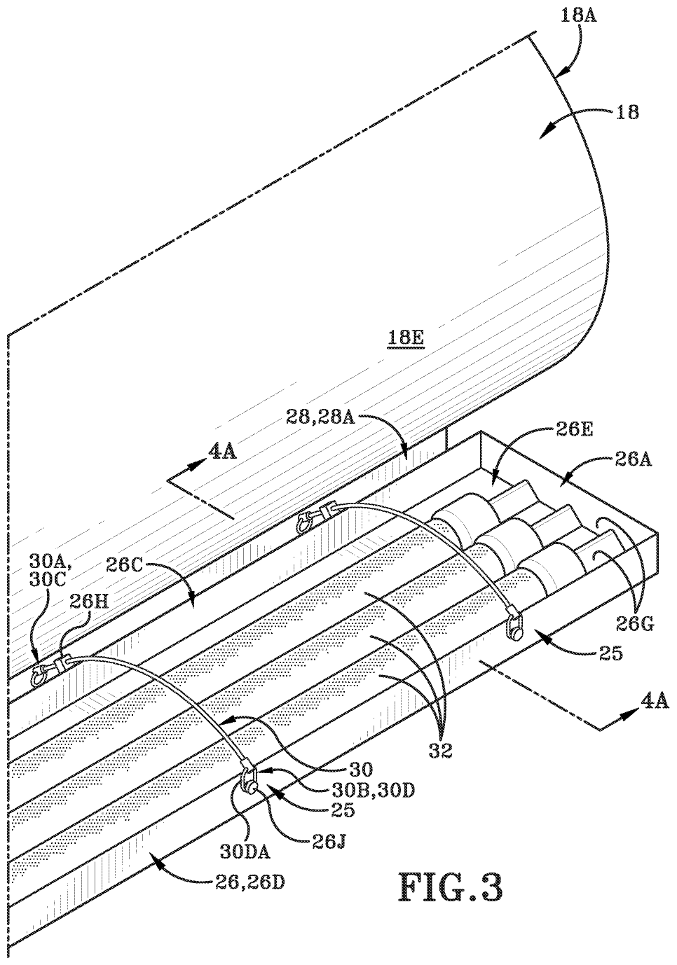

FIGS. 2-6 further depict the tank 18 and the hose holder 26. The tank 18 may include a first end 18A that faces the cab 12 and a second end 18B opposite the first end 18A. The tank 18 may further include a top side 18C and a bottom side 18D that is opposite the top side 18C. The tank 18 may also include a first side 18E and a second side 18F that is opposite the first side 18E. The tank 18 may further include a central longitudinal axis 18G, a central vertical axis 18H, and a central transverse axis 18I. The central longitudinal axis 18G may extend between the first end 18A and the second end 18B, the central vertical axis 18H may extend between the top side 18C and the bottom side 18D, and the central transverse axis 18I may extend between the first side 18E and the second side 18F. As further depicted in FIG. 2, a hose holder 26 may be adjacent to the first side 18E of the tank 18 and a hose holder 26 may be adjacent to the second side 18F of the tank 18. When the hose holder 26 is connected to the first side 18E or the second side 18F of the tank 18, the hose holder 26 may be parallel to the central longitudinal axis 18G.

The tank 18 includes a frame 28. The frame 28 includes a surface 28A. The hose holder 26 may be connected to the frame 28 and may be adjacent to the surface 28A of the frame 28. A plurality of flexible retaining rods 30 may attach to the hose holder 26. When attached to the hose holder 26, the flexible retaining rods 30 may retain one or more hoses 32 carried by the hose holder 26 while the vehicle 10 is stationary or moving.

The hose holder 26 may include a first end wall 26A and a second end wall 26B that is opposite the first end wall 26A. The hose holder may further include a first side wall 26C and a second side wall 26D that is opposite the first side wall 26C. The first end wall 26A and the second end wall 26B may extend between the first side wall 26C and the second side wall 26D. The hose holder 26 may further include a hose carrying bed or a bottom wall 26E. The first end wall 26A, the second end wall 26B, the first side wall 26C, and the second side wall 26D may extend from the bottom wall 26E. The bottom wall 26E may extend between the first end wall 26A, the second end wall 26B, the first side wall 26C, and the second side wall 26D. The hose holder 26 may further include a central vertical plane 26F. The central vertical plane 26F may extend between the first end wall 26A and the second end wall 26B. Furthermore, the central vertical plane 26F may extend from a midpoint of the first end wall 26A to a midpoint of the second end wall 26B. Accordingly, the central vertical plane 26F extends parallel to the central longitudinal axis 18G through a middle of the hose holder 26.

The first side wall 26C may include an inner surface 26CA and an outer surface 26CB that is opposite the inner surface 26CA. The inner surface 26CA may face the second side wall 26D and when the hose holder 26 is attached to the frame 28, the outer surface 26CB may face the surface 28A of the frame 28. The second side wall 26D may include an inner surface 26DA and an outer surface 26DB that is opposite the inner surface 26DA. The inner surface 26DA may face the first side wall 26C.

The bottom wall 26E may include a top surface 26EA and a bottom surface 26EB opposite the top surface 26EA. The first side wall 26C and the second side wall 26D may extend from the top surface 26EA of the bottom wall 26E. The bottom wall 26E may define one or more grooves 26G of the hose holder 26. While the hose holder 26 is depicted as including the grooves 26G, it is understood that the grooves 26G may be omitted from the hose holder 26. When omitted, the bottom wall 26E may be flat. When a hose 32 is within the hose holder 26, the hose 32 may rest between the inner surface 26CA of the first side wall 26C and the inner surface 26DA of the second side wall 26D and may rest upon the top surface 26EA of the bottom wall 26E. Furthermore, when the hose holder 26 includes the grooves 26G a hose 32 may rest within a groove 26G. The hose holder 26 may further include an anchor 26H. The anchor 26H may extend from the outer surface 26CB of the first side wall 26C. The anchor 26H may define an aperture 26HA that extends through the anchor 26H.

A flexible retaining rod 30 may include a first end 30A and a second end 30B opposite the first end 30A. A flexible retaining rod 30 may further include a first attachment assembly 30C, a second attachment assembly 30D and a flexible rod 30E. The first attachment assembly 30C may define the first end 30A of a flexible retaining rod 30 and the second attachment assembly 30D may define the second end 30B of a flexible retaining rod 30. Furthermore, the first attachment assembly 30C may include a first closed hook 30CA and the second attachment assembly 30D may include a second closed hook 30DA.

The flexible rod 30E may extend between the first attachment assembly 30C and the second attachment assembly 30D. The flexible rod 30E may be formed from a suitable flexible material. The flexible rod 30E may be formed from a flexible material including fiberglass, aluminum, carbon fiber, or springing steel; however other flexible materials are entirely contemplated. The flexible rod 30E may extend through the aperture 26HA of the anchor 26H. As a result, the anchor 26H may retain the flexible rod 30E.

FIGS. 2-5 depict the hose holder 26 with one or more catches 26J. A first catch 26J may include a first circular portion 26JA and a second circular portion 26JB. The first circular portion 26JA may extend from the outer surface 26DB of the second side wall 26D and the second circular portion 26JB may extend from the first circular portion 26JA. The first circular portion 26JA may have a diameter that is less than a diameter of the second circular portion 26JB.

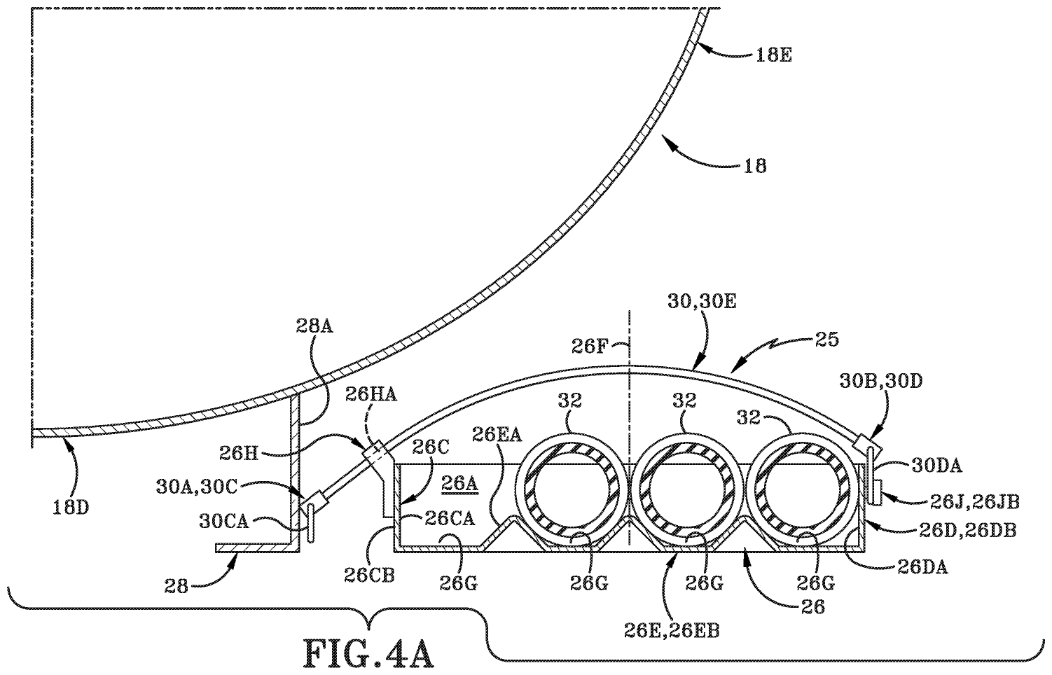

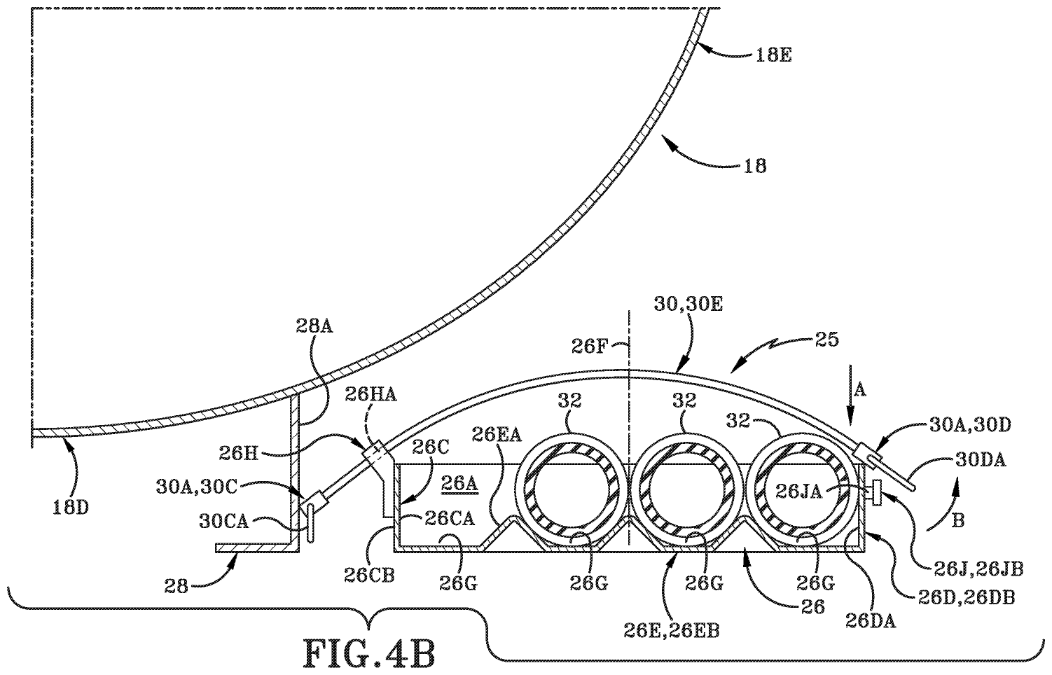

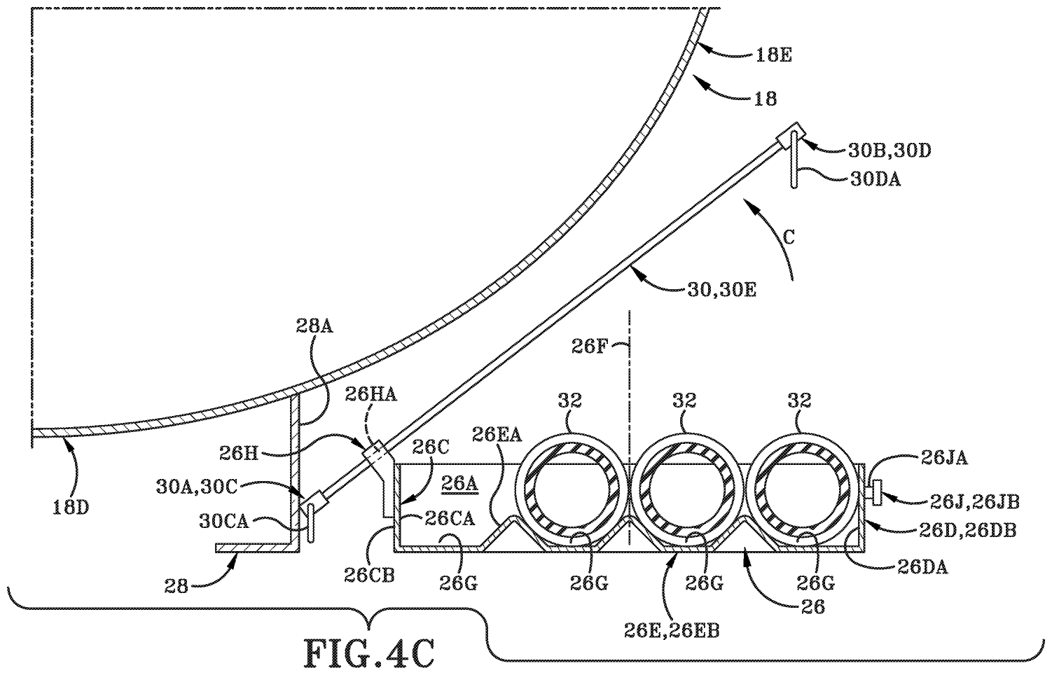

FIG. 4A depicts a retaining rod 30 in a closed positon. In the closed position, the flexible rod 30E may extend through the aperture 26HA and the second closed hook 30DA may attach to the first catch 26J. When attached to the first catch 26J, the second closed hook 30DA may nest between the outer surface 26DB of the second side wall 26D and the second circular portion 26JB and the second closed hook 30DA may extend around the first circular portion 26JA. Furthermore, when in the closed position, the flexible rod 30E may bend to a flexed position. When the flexible rod 30E is bent and the second attachment assembly 30D is attached to the first catch 26J, the flexible rod 30E stores potential energy. Furthermore, when in the closed position, the second closed hook 30DA may apply an upward force to the first catch 26J and the second closed hook 30DA may contact the first circular portion 26JA. This force may cause the second closed hook 30DA to stay attached to the first catch 26J.

When the flexible retaining rod 30 is in the closed position, the flexible retaining rod 30 may extend over the first side wall 26C, the second side wall 26D, and the bottom wall 26E. As a result, when the hoses 32 are carried by the hose holder 26, the one or more hoses 32 may rest between a flexible retaining rod 30 and the hose holder 26. Accordingly, when in the closed position, the flexible retaining rod 30 may retain the hoses 32 carried by the hose holder 26 while the vehicle 10 is stationary or moving.

As depicted in FIG. 4B, in order to release a second closed hook 30DA from a first catch 26J, a force may be applied in the direction of arrow A to a second attachment assembly 30D. When the force is applied to the second attachment assembly 30D, the second closed hook 30DA may no longer contact the first circular portion 26JA of the first catch 26J. When the second closed hook 30DA no longer contacts the first circular portion 26JA, the second closed hook 30DA may be moved in the direction of arrow B thereby releasing the second closed hook 30DA from the first catch 26J.

FIG. 4C depicts a flexible retaining rod 30 in an open position. A user may move the flexible retaining rod 30 from the closed position to the open position. The user may move the flexible retaining rod 30 from the closed position to the open position by releasing the second closed hook 30DA from the first catch 26J. When the second closed hook 30DA is released from the first catch 26J, the potential energy stored by the flexible retaining rod 30 is released and the flexible retaining rod 30 may automatically move in the direction of arrow C to the open position. At the open position, the flexible retaining rod may return to a natural positon, wherein the flexible retaining rod is generally straight.

When the flexible retaining rod 30 is in the open position, the first end 30A of the flexible retaining rod 30 may extend through the anchor 26H and over the first side wall 26C of the hose holder 26. Furthermore, when the flexible retaining rod 30 is in the open position, the flexible retaining rod 30 may extend beyond the central vertical plane 26F such that the second end 30B of the flexible retaining rod 30 is beyond the central vertical plane 26F relative to the vehicle 10 and the first side wall 26C. Also, when the flexible retaining rod 30 is in the open position, the second end 30B of the flexible retaining rod 30 may be vertically above the hose holder 26.

A user may move the flexible retaining rod 30 from the open position to the closed positon. When moved from the open position to the closed positon, the flexible retaining rod 30 slides through the aperture 26HA. The user may grasp the flexible retaining rod 30 at or near the second end 30B. The user may then pull the flexible retaining rod 30 in a downward direction towards the first catch 26J. After moving the second end 30B of the flexible retaining rod 30 towards the first catch 26J, the user may then attach the second closed hook 30DA to the first catch 26J. Since, when flexible retaining rod 30 is in the open position, the second end 30B extends beyond the central vertical plane 26F, the user does not have to reach over both the second side wall 26D and the first side wall 26C in order to place the flexible retaining rod 30 in a closed position. Accordingly, the user may not have to reach over all of the hoses 32 within the hose holder 26 in order to move the flexible retaining rod 30 from the open position to the closed position. Furthermore, since the second end 30B of the flexible retaining rod 30 remains vertically above the hose holder 26, a user may reach above the hoses 32 within the hose holder 26 in order to grasp the second end 30B when moving the flexible retaining rod 30 from the open position to the closed position. Hence, the user may not contact the hoses 32 or the hose holder 26 when moving the flexible retaining rod 30 from the open position to the closed position.

In one embodiment, the flexible retaining rod 30 may include a spring bias for moving rod from the closed position to the open position. The spring bias may include a spring. In this embodiment, the spring may be part of the flexible rod 30E. In this embodiment, the flexible rod 30E may comprise of a spring and a second flexible material (i.e., fiberglass, aluminum, carbon fiber, or springing steel). The spring may be located adjacent to the first attachment assembly 30C. The second material of the flexible rod 30E may extend between the spring and the second attachment assembly 30D. In one example, wherein the flexible rod 30E includes a spring, the spring of the flexible rod 30E may extend from the first attachment assembly 30C and the flexible rod 30E may further include carbon fiber that extends between the spring and the second attachment assembly 30D. In another example, wherein the flexible rod 30E includes a spring, the spring of the flexible rod 30E may extend from the first attachment assembly 30C and the flexible rod 30E may further include fiberglass that extends between the spring and the second attachment assembly 30D.

Furthermore, in this embodiment, the spring may be a tension spring. When the flexible retaining rod 30 is in the open position, spring extends generally straight from the first attachment assembly 30C. When the flexible retaining rod 30 is in the closed positon, the spring is bent. When the spring is bent and the flexible retaining rod 30 is in the closed positon, the spring stores potential energy. When the second attachment assembly 30D is released from the first catch 26J, the potential energy stored in the spring is released and the spring automatically returns to a straight position. Accordingly, the flexible retaining rod 30 is automatically returned to the open position when the second attachment assembly 30D is released from the second catch 26K.

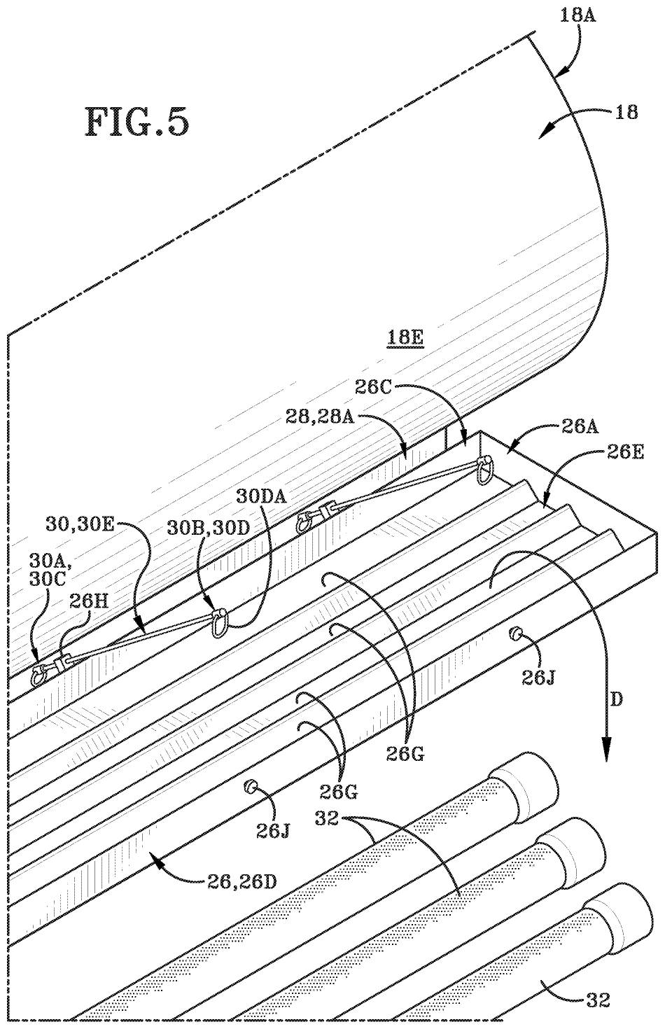

As depicted in FIG. 5, when the second closed hook 30DA has been released from the first catch 26J and the flexible retaining rods 30 are in the open position, the hoses 32 may be moved in the direction of arrow D and removed from the hose holder 26.

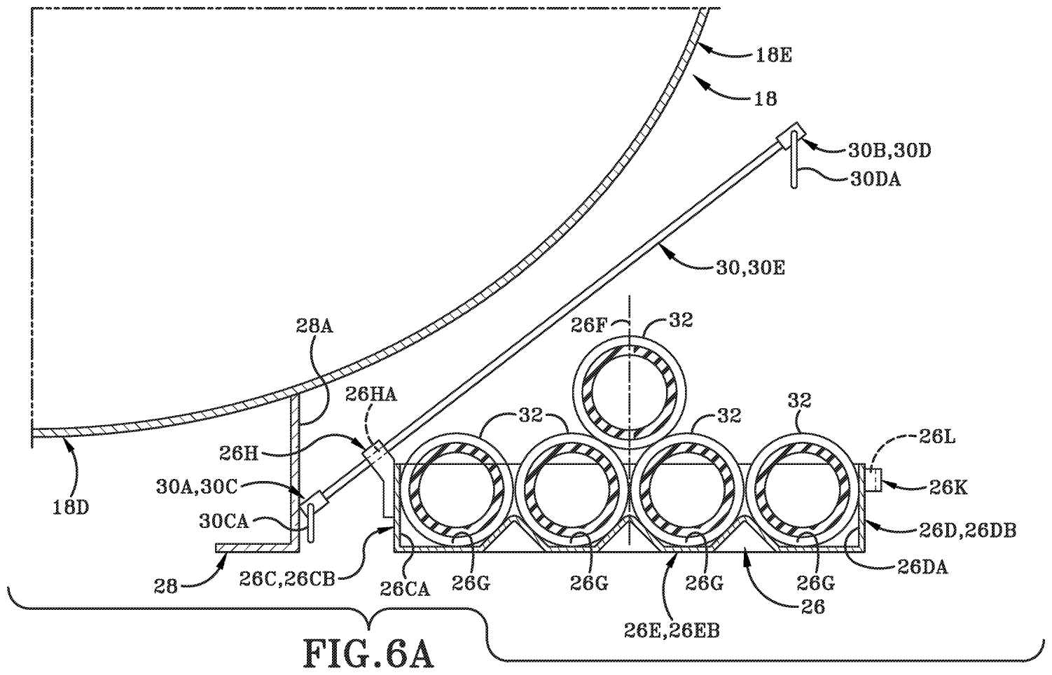

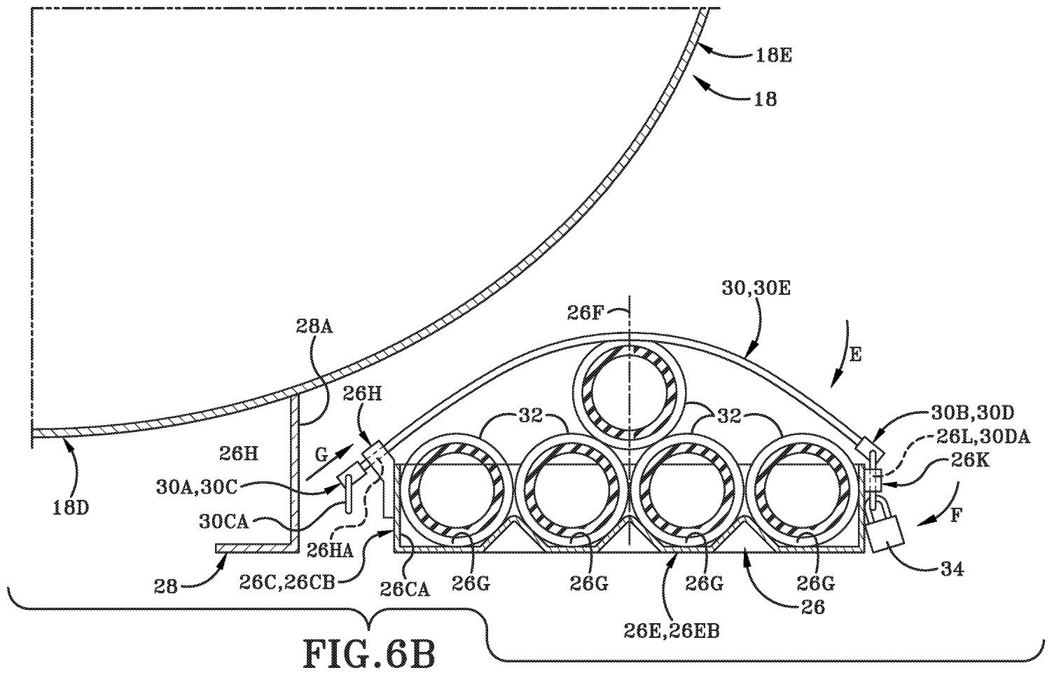

FIG. 6A depicts the hose holder 26 with a second catch 26K and a flexible retaining rod 30 in an open position. When in the open position, the flexible rod 30E may extend through the aperture 26HA of the anchor 26H and the flexible retaining rod 30 may be generally straight. FIG. 6B depicts the hose holder 26 with the second catch 26K and the retaining rod 30 in a closed position. The flexible retaining rod 30 may be moved from the open position to the closed position by moving the flexible retaining rod 30 in the direction of arrow E. The second catch 26K may extend from the outer surface 26DB of the second side wall 260. The second catch 26K and the outer surface 26DB may define an aperture 26L that extends the length of the second catch 26K. The aperture 26L may have a width that is wider than a width of a second closed hook 30DA of a flexible retaining rod 30. After moving the flexible retaining rod 30 in the direction of arrow E, the second closed hook 30DA may be moved in the direction of arrow F and the second closed hook 30DA may extend through the aperture 26L. After extending through the aperture 26L, a lock 34 may pass through an opening of the second closed hook 30DA and lock to the second closed hook 30DA. The size of the lock 34 may be larger than the aperture 26L. When in the closed positon, the flexible rod 30E may bend into a flexed position. When bent, and when the lock 34 is locked to the second closed hook 30DA, the lock 34 may apply an upward force to the second catch 26K. Since the lock 34 may be larger than the aperture 26L, the lock 34 may not pass through the aperture 26L and the lock 34 may contact the second catch 26K which may maintain the flexible retaining rod 30 in the closed position.

When the in the closed position, the flexible retaining rod 30 and the hose holder 26 may retain at least one hose 32 that is not within the hose holder 26. For example, as depicted in FIGS. 6A and 6B, the hose holder 26 may include four grooves 26G. In this example, each groove 26G retains a hose 32. Accordingly, four hoses 32 may be retained within the hose holder 26. Furthermore, a fifth hose 32 may be stacked upon at least two of the four hoses 32 that are within the hose holder 26. When the hoses 32 are in this position, and a flexible retaining rod 30 is in the closed positon, the flexible retaining rod 30 may extend over the first side wall 26C, the second side wall 26D, and the bottom wall 26E. As a result, the five hoses 32 may be between the hose holder 26 and the flexible retaining rod 30 when the flexible retaining rod 30 is in the closed positon. Accordingly, the hose holder 26 and the flexible retaining rod 30 may retain the five hoses 32 while the vehicle 10 is stationary or moving. As depicted in FIG. 6B, the flexible retaining rod 30 may be moved in the direction of arrow G through the aperture 26HA of the anchor 26H in order to retain additional hoses 32.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A vehicle comprising:
a tank;
a hose holder connected to the vehicle and positioned adjacent to the tank, wherein the hose holder includes a hose carrying bed;
a retaining rod connected to the hose holder, wherein the retaining rod extends over the hose carrying bed.

2. The vehicle of claim 1, wherein the hose holder further includes a first side wall adjacent to the tank and a second side wall spaced from the first side wall and a catch, wherein the hose carrying bed extends between the first side wall and the second side wall, and wherein the catch extends from the second side wall and the retaining rod is removably attached to the catch.

3. The vehicle of claim 2, wherein the retaining rod is moveable between an open position and a closed position, and wherein the retaining rod is releasably attached to the catch.

4. The vehicle of claim 3, wherein the retaining rod includes a first end, a second end opposite the first end, an attachment assembly that defines the second end, and wherein the attachment assembly is removably attached to the catch.

5. The vehicle of claim 4, wherein the attachment assembly includes a closed hook that is removably attached to the catch.

6. The vehicle of claim 3, wherein the hose holder includes an anchor carried by the first side wall, wherein the anchor retains the retaining rod.

7. The vehicle of claim 6, wherein the anchor defines an aperture and a portion of the retaining rod extends through the aperture.

8. The vehicle of claim 3, wherein the retaining rod is manufactured of a flexible material.

9. The vehicle of claim 8, wherein the flexible material is one of fiberglass, aluminum, carbon fiber, or springing steel.

10. The vehicle of claim 3, further comprising:
a spring bias for moving the retaining rod from the closed positon to the open position.

11. The vehicle of claim 10, wherein the spring bias includes a sprig for moving the retaining rod from the closed position to the open position.

12. The vehicle of claim 3, further comprising:
a central vertical plane extending through hose holder bed, wherein the retaining rod extends at least to the central vertical plane when in the open position.

13. A method for retaining hoses comprising:
placing a hose into a hose holder, wherein the hose holder is connected to a vehicle; and
moving a retaining rod from an open position to a closed positon, wherein in the open position a first end of the retaining rod is attached to the hose holder and in the closed position the first end and a second end of the retaining rod are attached to the hose holder.

14. The method of claim 13, wherein when the retaining rod is in the open position, the second end of the retaining rod is vertically above a hose holder bed of the hose holder.

15. The method of claim 14, wherein when the retaining rod is in the open position, the second end of the retaining rod extends beyond the second end of the retaining rod extends beyond a central vertical plane of the hose holder relative to the vehicle.

16. The method of claim 15, wherein the hose holder includes a catch and wherein the method further includes attaching the second end of the retaining rod to the catch thereby placing the retaining rod in the closed positon.

17. The method of claim 16, further comprising:
overcoming a spring bias to move the retaining rod from the open position to the closed position.

18. The method of claim 17, wherein the step of overcoming the spring bias to move the retaining rod from the open position to the closed position includes flexing a flexible rod of the retaining rod.

19. The method of claim 17, wherein the spring bias automatically moves the retaining rod from the closed position to the open position.

20. The method of claim 18, wherein attaching the second end of the retaining to the catch causes the retaining to store potential energy.

21. The method of claim 19, further comprising:
releasing the second end of the retaining rod from the catch, wherein releasing the second end of the retaining rod from the catch causes the retain rod to release the stored potential energy thereby moving the retaining rod to the open position.
